(19) United States
(12) Patent Application Publication
(10) Pub. No.: US 2002/0114127 A1
(43) Pub. Date: Aug. 22, 2002

(54) Capacitor for a power semiconductor module

(76) Inventors: Beat Guggisberg, Untersiggenthal (CH); Pieder Jorg, Ems/Domat (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/022,243

(22) Filed: Dec. 20, 2001

(30) Foreign Application Priority Data
Dec. 21, 2000 (EP) 00 811 219.5

(51) Int. Cl. H01G 4/228

(52) U.S. Cl. 361/309

(57) ABSTRACT

A capacitor for a power semiconductor module (7) is specified, which has a capacitor housing (1) and pole bushings (3a; 3b) from the interior of the capacitor housing (1) to the exterior, with a first pole bushing (3a) forming a negative pole and a second pole bushing (3b) forming a positive pole. Furthermore, the pole bushings (3a; 3b) are each integral, and connecting ends (8) of the pole bushings (3a; 3b) are each designed such that they can be connected to connecting terminals (5) on the power semiconductor module (7). This results in a capacitor with a particularly simple construction and with a low overall inductance.

### DESCRIPTION

1. Technical Field

The present invention relates to the field of power electronics. It relates in particular to a capacitor for a power semiconductor module as claimed in the precharacterizing clause of the independent claim.

2. Prior Art

Power semiconductor modules are nowadays used in a range of converter circuits. Normally, a power semiconductor module is formed from a number of power semiconductors. When used in converter circuits, in particular in converter circuits in the form of inverter circuits, such power semiconductor modules are connected in parallel with one another in order to allow a high current to be switched at a predetermined, high power level. Furthermore, particularly in the case of inverter circuits, the power semiconductor modules are connected to one or more capacitors, which are generally used as energy stores.

Such a capacitor has a capacitor winding in the interior of its housing. The capacitor winding is essentially formed from two conductive foils which are insulated from one another, with the foils being wound one inside the other, for example. Each foil is connected to a pole bushing, each of which passes through the capacitor housing, with a first pole bushing forming a positive pole connection outside the capacitor housing, and a second pole bushing forming a negative pole connection.

A conventional low-inductance busbar system, such as that which is known from “Power Conversion Applications, ELDRE CORPORATION, http://www.eldre.com, Nov. 16, 2000” is used to connect the individual pole connections of the capacitor to the power semiconductor module. To this end, this busbar system is connected firstly by means of respective connection means to the positive pole connection and to the negative pole connection of the capacitor, and is secondly in each case connected to the associated connecting terminals of the power semiconductor module.

Since the semiconductor modules that are used nowadays produce a high current rate of change during switching operation, the overall inductance must be as low as possible in order to ensure that any overvoltage resulting from a large overall inductance does not destroy the semiconductor module when a switching process takes place in said power semiconductor module. The overall inductance is formed by the inductance of the capacitor winding, the bushing, the connection means, the busbar system and by the inductance of the power semiconductor module. Although the busbar system is already designed to have a low inductance, as specified in “Power Conversion Applications, ELDRE CORPORATION, http://www.eldre.com, Nov. 16, 2000”, the overall inductance is, as before, very high due to the other components which have been described above and are the major factors governing the overall inductance, in particular due to the connection means, so that the power semiconductor module is subject to an increased risk of destruction by overvoltage, and/or a shortened aging process resulting from the frequent occurrence of an increased voltage.

Although circuitry measures are known, for example circuitry to connect the connecting terminals of the power semiconductor module to clamping capacitors, in order to reduce any overvoltages which may occur, measures such as these result in a high level of assembly complexity, use of a large amount of materials, and thus significant costs.

3. Description of the Invention

One object of the invention is therefore to design a capacitor for a power semiconductor module in such a manner that the overall inductance formed by capacitor elements and power semiconductor module elements can be reduced, while at the same time minimizing the assembly complexity and the use of material. This object is achieved by the features of claim 1. Advantageous developments of the invention are specified in the dependent claims.

In the capacitor according to the invention for a power semiconductor module, the capacitor has a capacitor housing and pole bushings from the interior of the capacitor housing to the exterior, with the pole bushings, according to the invention, each being integral. Furthermore, according to the invention, connecting ends of the pole bushings are each designed such that they can be connected to connecting terminals on the power semiconductor module. This advantageously means that there is no need for any busbar system or the connection means normally required for such a system, thus resulting in a particularly effective reduction in the overall inductance, while it is possible to keep the use of material, the costs involved and the assembly complexity low. Furthermore, the reduced overall inductance minimizes any overvoltage which may occur due to an excessively high overall inductance during a switching process in the power semiconductor module. Furthermore, the reliability of the capacitor and of the power semiconductor module is improved, since the number of elements is reduced.

In one preferred exemplary embodiment of the capacitor according to the invention, an insulation body is provided, which electrically isolates the pole bushings from one another and from the capacitor housing. Any short circuit which may occur due to voltage flashovers between the pole bushings can thus be advantageously counteracted. In addition, any disturbance of the two pole bushings, in particular in the event of mechanical influences, is avoided, so that the pole bushings are made more resistant to such influences.

This and further objects, advantages and features of the present invention will become clear from the following detailed description of a preferred exemplary embodiment of the invention, in conjunction with the drawing.

### BRIEF DESCRIPTION OF THE DRAWING

In the figures:

FIG. 1 shows a schematic illustration of a first embodiment of a capacitor according to the invention for a power semiconductor module, in the form of a side view,

FIG. 2 shows a three-dimensional illustration of the capacitor according to the invention and as shown in FIG. 1, and

FIG. 3 shows a three-dimensional illustration of a second embodiment of the capacitor according to the invention for a power semiconductor module.

The reference symbols used in the drawing and their meanings are listed in summary form in the List of Reference Symbols. In principle, identical parts are provided with identical reference symbols in the figures. The described embodiments are represented as examples of the subject matter of the invention, and have no restrictive effect.

### Approaches to Implementation of the Invention

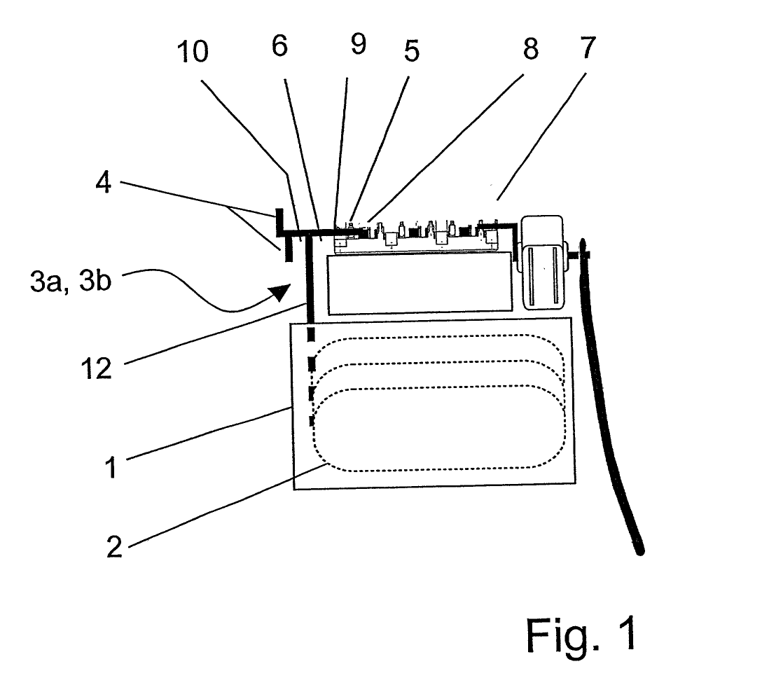

FIG. 1 shows a schematic illustration of a first embodiment of a capacitor according to the invention for a power semiconductor module 7, in the form of a side view. The capacitor has a capacitor housing 1, in whose interior at least one capacitor winding 2 is provided, whose winding structure determines a capacitance value. It is also feasible for an arrangement in the form of plates to be provided instead of the capacitor winding 2. The capacitor winding 2 as shown in FIG. 1 is normally formed from essentially two conductive foils, which are insulated from one another. The foils are in this case wound one inside the other, although the individual foils are not shown in FIG. 1, for the sake of clarity. Each foil is connected to a respective pole bushing 3a, 3b, which each pass from the interior of the capacitor housing 1 to the exterior. In this case, a first pole bushing 3a forms a negative pole, and a second pole bushing 3b forms a positive pole, of the capacitor.

Furthermore, according to the invention and as shown in FIG. 1, the pole bushings 3a, 3b each have a first angle 6 outside the capacitor housing 1, which angle 6 is designed to minimize the distance from the connection of the capacitor to the power semiconductor module 7, in particular to its connecting terminals 5. As shown in FIG. 1, this short distance is achieved by the first angle 6 being at least approximately rectangular, and facing the connecting terminals 5. As shown in FIG. 1, the first angle 6 is in each case formed by a part 12 of the pole bushings 3a, 3b which emerges from the capacitor housing 1, and by a connecting guide 9 for the respective pole bushing 3a, 3b, with the connecting guide 9 of the respective pole bushing 3a, 3b running in the direction of the connecting terminals 5. This advantageously results in a desired reduction in the overall inductance since less material is used. The connecting guides 9 of the pole bushings 3a, 3b end in connecting ends 8, with each connecting guide 9 having one connecting end 8. The connecting end 8 thus forms a first end of each pole bushing 3a, 3b outside the capacitor housing 1.

According to the invention, the pole bushings 3a, 3b are each integral, with the connecting ends 8 each being designed such that they can be connected to connecting terminals 5 on the power semiconductor module 7. It is thus possible to produce a particularly simple connection, in particular a plug connection, between the capacitor and the connecting terminals 5 of the power semiconductor module 7, and this is distinguished by its assembly simplicity and the use of little material. In order to improve the mechanical robustness of this connection, the plug connection can also be fixed by a screw connection. Furthermore, there is no need for any complex busbar system with the connection means normally required for this purpose between the connecting terminals 5 and the capacitor, in particular between the connecting terminals 5 of the two poles of the capacitor, so that it is advantageously possible to save further assembly and material costs. In addition, this means that the overall inductance, which is composed of the capacitor elements and the power semiconductor module elements, is reduced. This reduction in the overall inductance means that the power semiconductor module 7 is protected against overvoltages caused by switching processes, since any occurrence of such overvoltages is successfully minimized by the reduction in the overall inductance. Furthermore, the aging process of the power semiconductor module 7 is slowed down considerably.

Furthermore, as shown in FIG. 1, the pole bushings 3a, 3b each have a second angle 10 in the region of the first angle 6 outside the capacitor housing 1, which second angle 10 is at least approximately rectangular and faces away from the connecting terminals 5. As shown in FIG. 1, the second angle 10 is in each case formed by that part 12 of the pole bushings 3a, 3b which emerges from the capacitor housing 1 and by a busbar connecting element 4 for the respective pole bushing 3a, 3b, with the busbar connecting element 4 running in the opposite direction to the connecting guide 9, but preferably being aligned with it in a plane. However, it is also feasible for the busbar connecting element 4 not to be aligned in a plane with the connecting guide 9, but to run offset with respect to it. The busbar connecting element 4 itself is preferably angular, and advantageously has a rectangular shape. The busbar connecting element 4 makes it possible to fit a busbar device, which is not shown in FIG. 1 for the sake of clarity but is used, for example, for connecting the respective pole bushings 3a, 3b of identical polarity of a number of capacitors in parallel with one another to form a capacitor bank. The preferably rectangular busbar connecting elements 4 make it particularly simple to fit a conventional busbar device in the form of a plate, since no specially designed busbar device is required. The angular busbar connecting elements 4 of the pole bushings 3a, 3b have mutually opposite terminating directions, as shown in FIG. 1, thus making it particularly simple to create a separation when fitting the busbar device mentioned above. The busbar connecting element 4 furthermore forms a second end of the associated pole bushing 3a, 3b outside the capacitor housing 1. This measure allows the use of material for the pole bushings 3a, 3b to be kept low, furthermore making it possible to keep the overall inductance low in the desired manner.

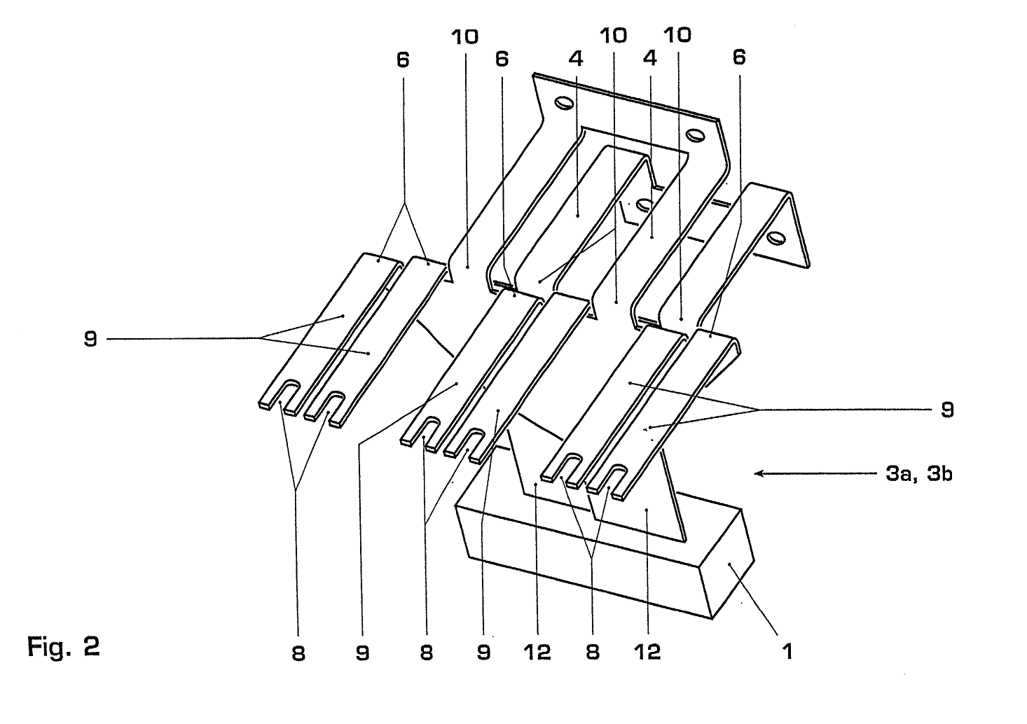

FIG. 2 shows a three-dimensional illustration of the capacitor according to the invention as shown in FIG. 1. In this figure, the pole bushings 3a, 3b have a profile in the form of plates and, furthermore, are composed of an electrically conductive, low-inductance material. This means that the overall inductance can advantageously very effectively be reduced further. As shown in FIG. 2, after emerging from the capacitor housing 1, each pole bushing 3a, 3b has a flat broadened region, which is used to carry current better, as far as the respective first angle 6 or second angle 10 from where, as already mentioned, firstly, the connecting guide 9 of the respective pole bushings 3a, 3b runs in the direction of the connecting terminals 5 and, secondly, the busbar connecting element 4 of the respective pole bushings 3a, 3b runs in the opposite direction to the connecting guide 9. The broadened region of the pole bushings 3a, 3b is essentially triangular, as shown in FIG. 2, with the pole bushings being arranged asymmetrically with respect to one another in this region. Particularly in the region where the pole bushings 3a, 3b emerge from the capacitor housing 1, said pole bushings 3a, 3b run essentially parallel to one another and, as shown in FIG. 2, are at a sufficient distance from one another to prevent short circuits between the pole bushings 3a, 3b as a result of voltage flashovers. Furthermore, each pole bushing 3a, 3b as shown in FIG. 2 has three connecting guides 9 with the connecting ends 8 which end at them. This embodiment of the pole bushings 3a, 3b allows the capacitor for a power semiconductor module 7 to be connected to three respective connecting terminals 5 per pole. It is self-evident that the number of connecting guides 9 can be varied with a predetermined number of connecting terminals 5, with each pole bushing 3a, 3b having at least one connecting guide 9 with the connecting end 8 which ends at it.

As shown in FIG. 2, the connecting ends 8 are preferably designed such that they can be plugged in. This allows the power semiconductor module 7 to be connected in a particularly simple and rapid manner by its connecting terminals 5 to the pole bushings 3a, 3b, and hence to the capacitor, thus allowing quick and hence effective maintenance, for example when replacing the power semiconductor module 7 and/or the capacitor. It has been found to be advantageous to design each of the connecting ends 8 essentially with a fork-shape, with each terminating end 8 essentially forming a U-shape. This makes it possible for the connecting ends 8 to be worn as little as possible when making the plug connection to the connecting terminals 5, and when detaching this connection. In order to improve the mechanical robustness, the connection between the power semiconductor module 7 and the capacitor at the connecting terminals 5 can also be fixed by a screw connection.

Furthermore, the busbar element 4 shown in FIG. 2 is designed to have two limbs in the region of the second angle 10, with the already mentioned angular configuration of the busbar element 4 being produced by a connection, which is fitted in this angle and is in the form of a plate, at right angles to the two limbs. The connection preferably has holes so that the already mentioned busbar device can be fitted using conventional connection means.

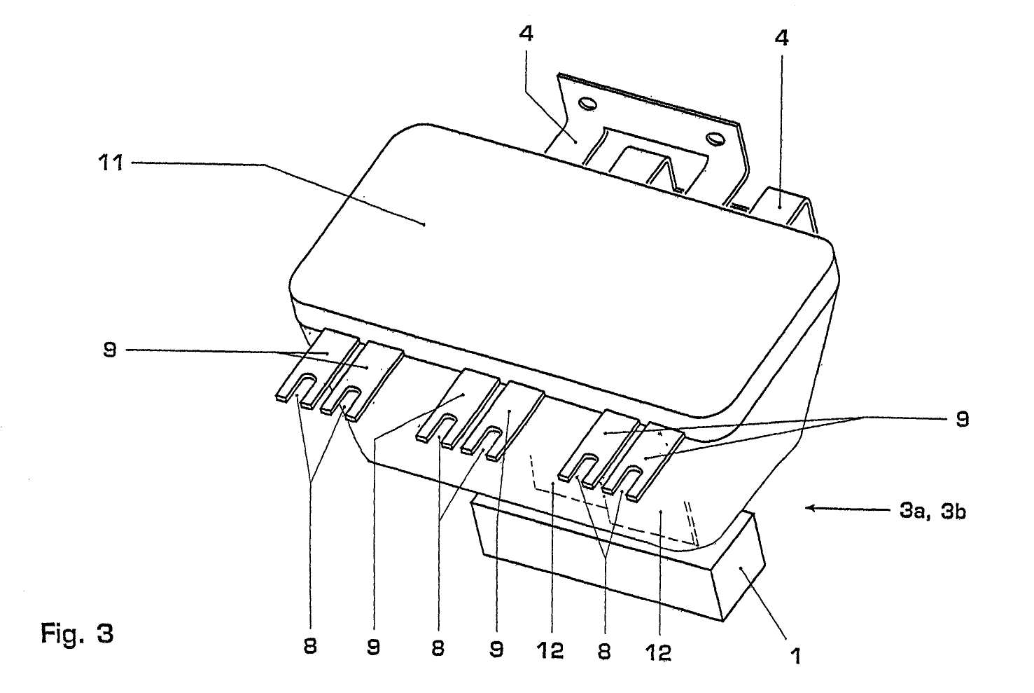

FIG. 3 shows a three-dimensional illustration of a second embodiment of the capacitor according to the invention for a power semiconductor module 7, with the pole bushings 3a, 3b being designed as shown in FIG. 1 and FIG. 2. According to the invention, an insulation body 11 is provided which electrically isolates the pole bushings 3a, 3b from one another and also isolates the pole bushings 3a, 3b from the capacitor housing 1. The insulation body encloses the pole bushings 3a, 3b, in particular that part 12 of the pole bushings 3a, 3b which emerges from the capacitor housing 1 and in which they are guided essentially parallel, while maintaining the distance between the pole bushings 3a, 3b. Furthermore, the insulation body 11 encloses the pole bushings 3a, 3b in the region of the first angle 6, in the region of the second angle 10, and at least partially encloses the connecting guides 9 and the busbar connecting elements 4. This successfully reduces the probability of a short circuit occurring due to voltage flashovers, particularly in the region where the pole bushings 3a, 3b emerge, as well as in the other regions of the pole bushings 3a, 3b, which are surrounded by the insulation body, as described above. Furthermore, the insulation body 11 prevents any disturbance of the pole bushings 3a, 3b, in particular in the event of any mechanical influences on the pole bushings 3a, 3b, such as those which can occur due to mechanical vibration or oscillations. The pole bushings 3a, 3b are thus made more robust by means of the insulation body 11. The insulation body 11 is preferably a casting, so that those regions of the pole bushings 3a, 3b which have been described above can be enclosed in an optimum manner by the insulation material of the insulation body 11.

Overall, the capacitor according to the invention represents a particularly simple solution, which is also cost-effective and reliable owing to the small number of elements used, and which is furthermore distinguished by low overall inductance, including the power semiconductor module elements.

List of reference symbols

| | |
|---|---|
| 1 | Capacitor housing |
| 2 | Capacitor winding |
| 3a, 3b | Pole bushing |
| 4 | Busbar connecting element |
| 5 | Connecting terminals |
| 6 | First angle |
| 7 | Power semiconductor module |
| 8 | Connecting ends |
| 9 | Connecting guide |
| 10 | Second angle |
| 11 | Insulation body |
| 12 | Part of the pole bushing emerging from the |
| | capacitor housing |

1. A capacitor for a power semiconductor module (7), which has a capacitor housing (1) and pole bushings (3a; 3b) from the interior of the capacitor housing (1) to the exterior, with a first pole bushing (3a) forming a negative pole and a second pole bushing (3b) forming a positive pole, characterized in that the pole bushings (3a; 3b) are each integral, and in that connecting ends (8) of the pole bushings (3a; 3b) are each designed such that they can be connected to connecting terminals (5) on the power semiconductor module (7).

2. The capacitor as claimed in claim 1, characterized in that the pole bushings (3a; 3b) have a profile in the form of a plate.

3. The capacitor as claimed in one of claims 1 or 2, characterized in that the connecting ends (8) are designed such that they can be plugged in.

4. The capacitor as claimed in claim 3, characterized in that the connecting ends (8) are each essentially fork-shaped, with each connecting end (8) essentially forming a U-shape.

5. The capacitor as claimed in one of the preceding claims, characterized in that each pole bushing (3a; 3b) has at least one connecting guide (9) with a connecting end (8) ending at it, and in that a part (12) of the pole bushings (3a; 3b) which emerges from the capacitor housing (1) in each case forms a first angle (6) with the connecting guide (9) of the respective pole bushing (3a; 3b).

6. The capacitor as claimed in claim 5, characterized in that the connecting guide (9) runs in the direction of the connecting terminals (5).

7. The capacitor as claimed in one of claims 5 or 6, characterized in that, in the region of the first angle (6), each pole bushing (3a; 3b) has a second angle (10) which faces away from the connecting terminals (5), and in that each pole bushing (3a; 3b) has a busbar connecting element (4) which in each case forms the second angle (10) with that part (12) of the pole bushings (3a; 3b) which emerges from the capacitor housing (1), with the busbar connecting element (4) running in the opposite direction to the connecting guide (9).

8. The capacitor as claimed in claim 7, characterized in that the busbar connecting element (4) is angular.

9. The capacitor as claimed in claim 8, characterized in that the busbar connecting elements (4) of the pole bushings (3a; 3b) have opposite terminating directions to one another.

10. The capacitor as claimed in claims 5 and 7, characterized in that, in the region where they emerge from the capacitor housing (1), the pole bushings (3a; 3b) have a flat broadened region as far as the first angle (6) and, respectively, as far as the second angle (10).

11. The capacitor as claimed in claim 10, characterized in that an insulation body (11) is provided, which electrically isolates the pole bushings (3a; 3b) from one another.

12. The capacitor as claimed in claim 10, characterized in that the insulation body (11) encloses the pole bushings (3a; 3b) in the region where the pole bushings (3a; 3b) emerge from the capacitor housing (1).

13. The capacitor as claimed in one of claims 10 to 12, characterized in that the insulation body (11) encloses the pole bushings (3a; 3b) in the region of the first angle (6) and in the region of the second angle (10).

14. The capacitor as claimed in one of claims 10 to 13, characterized in that the insulation body (11) at least partially encloses the connecting guides (9) and the busbar connecting elements (4).
